(19) United States
(12) Patent Application Publication
(10) Pub. No.: US 2025/0180731 A1
(43) Pub. Date: Jun. 5, 2025

(54) TRACKING A TARGET USING DOPPLER SHIFT

(71) Applicants: Todd Moon, Providence, UT (US); Thomas Bradshaw, Albuquerque, NM (US)

(72) Inventors: Todd Moon, Providence, UT (US); Thomas Bradshaw, Albuquerque, NM (US)

(73) Assignee: Utah State University, Logan, UT (US)

(21) Appl. No.: 19/050,718

(22) Filed: Feb. 11, 2025

Related U.S. Application Data
(63) Continuation-in-part of application No. 18/212,344, filed on Jun. 21, 2023.
Application No. 18/212,344 is a continuation-in-part of application No. 17/332,556, filed on May 27, 2021, now abandoned.
(60) Provisional application No. 63/030,813, filed on May 27, 2020.

(51) Int. Cl. G01S 13/72; G01S 13/00; G01S 13/58

(52) U.S. Cl. CPC G01S 13/723; G01S 13/589; G01S 13/003

(57) ABSTRACT

For tracking a target, method detects, by use of a processor, that the target is present. The method estimates an initial target position. The method further tracks the target position from channel state information Doppler frequency measurements using at least one of an extended Kalman filter, a Viterbi algorithm, and a particle filter.

### CROSS-REFERENCE TO RELATED APPLICATIONS

This application is a continuation-in-part application of and claims priority to U.S. patent application Ser. No. 18/212,344 entitled “TRACKING A TARGET USING DOPPLER SHIFT” and filed on Jun. 21, 2023 for Todd Moon, which is incorporated by reference.

FEDERALLY SPONSORED RESEARCH AND DEVELOPMENT

This invention was made with government support under contract no. H98230-18-C-0172 awarded by the Department of Defense. The government has certain rights in the invention.

### BACKGROUND INFORMATION

The subject matter disclosed herein relates to tracking a target and more particularly relates to tracking a target using Doppler shift.

### BRIEF DESCRIPTION

A method of tracking a target is disclosed. The method detects, by use of a processor, that a target is present. The method estimates an initial target position. The method further tracks the target position from channel state information Doppler frequency measurements using at least one of an extended Kalman filter, a Viterbi algorithm, and a particle filter. An apparatus and computer program product also perform the invention.

### BRIEF DESCRIPTION OF DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating one embodiment of a target system;

FIG. 1B is a schematic block diagram illustrating one alternate embodiment of a target system;

FIG. 1C is a schematic block diagram illustrating one alternate embodiment of a target system;

FIG. 1D is a schematic diagram illustrating one embodiment of a target system;

FIG. 1E is a schematic diagram illustrating one alternate embodiment of a target system;

FIG. 2A is a schematic block diagram illustrating one embodiment of Doppler information;

FIG. 2B is a schematic block diagram illustrating one embodiment of a transmitter/receiver pair;

FIG. 2C is a schematic block diagram illustrating orthogonal frequency division multiplexing (OFDM) signals;

FIG. 2D is a schematic block diagram illustrating one embodiment of a data sequence;

FIG. 2E is a schematic block diagram illustrating one embodiment of data functions;

FIG. 3A is a diagram illustrating one embodiment of a Fourier transform;

FIG. 3B is a graph illustrating one embodiment of CSI Fourier transforms;

FIG. 3C is a graph illustrating one embodiment of a Fourier transform sum;

FIG. 3D is a graph illustrating one embodiment of a central lobe template;

FIG. 3E is a graph illustrating one embodiment of a side lobe template;

FIG. 3F is a graph illustrating one embodiment of template matching;

FIG. 4A is a drawing illustrating one embodiment of a position line;

FIG. 4B is a drawing illustrating one embodiment of position lines;

FIG. 4C is a drawing illustrating one embodiment of position intersections;

FIG. 4D is a drawing illustrating one embodiment of position intersections and a target position;

FIG. 5 is a schematic block diagram illustrating one embodiment of a computer;

FIG. 6A is a schematic flow chart diagram illustrating one embodiment of a tracking

method;

FIG. 6B is a schematic flow chart diagram illustrating one embodiment of a target position estimation method;

FIG. 6C is a schematic flow chart diagram illustrating one embodiment of a target tracking method;

FIG. 7 is a drawing illustrating one embodiment of Doppler extracted from a target;

FIG. 8 is a graph illustrating one embodiment of target tracking;

FIG. 9 is graphs illustrating one embodiment of Doppler from multiple receivers;

FIG. 10A is a top view drawing illustrating one embodiment of target positions in a building;

FIG. 10B is a top view drawing illustrating one embodiment of initial target positions in a building;

FIG. 10C is a top view drawing illustrating one embodiment of estimated target positions in a building starting from a true initial target position; and

FIG. 10D is a top view drawing illustrating one embodiment of target positions in a building starting from an incorrect initial target position.

### DETAILED DESCRIPTION

It will be appreciated by one skilled in the art, aspects of the embodiments may be embodied as a system, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing computer readable code. The storage devices may be tangible, non-transitory, and/or non-transmission.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in computer readable code and/or software for execution by various types of processors. An identified module of computer readable code may, for instance, comprise one or more physical or logical blocks of executable code which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of computer readable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices, and may exist, at least partially, merely as electronic signals on a system or network. Where a module or portions of a module are implemented in software, the software portions are stored on one or more computer readable storage devices.

Any combination of one or more computer readable medium may be utilized. The computer readable medium may be a computer readable signal medium or a computer readable storage medium. The computer readable storage medium may be a storage device storing the computer readable code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable code embodied therein, for example, in baseband or as part of a carrier wave. Such a propagated signal may take any of a variety of forms, including, but not limited to, electro-magnetic, optical, or any suitable combination thereof. A computer readable signal medium may be any storage device that is not a computer readable storage medium and that can communicate, propagate, or transport a program for use by or in connection with an instruction execution system, apparatus, or device. Computer readable code embodied on a storage device may be transmitted using any appropriate medium, including but not limited to wireless, wire line, optical fiber cable, Radio Frequency (RF), etc., or any suitable combination of the foregoing.

Computer readable code for carrying out operations for embodiments may be written in any combination of one or more programming languages, including an object-oriented programming language such as Python, Ruby, R, Java, Java Script, Smalltalk, C++, C sharp, Lisp, Clojure, PHP, MATLAB, or the like and conventional procedural programming languages, such as the “C” programming language or similar programming languages. The computer readable code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

The embodiments may transmit data between electronic devices. The embodiments may further convert the data from a first format to a second format, including converting the data from a non-standard format to a standard format and/or converting the data from the standard format to a non-standard format. The embodiments may modify, update, and/or process the data. The embodiments may store the received, converted, modified, updated, and/or processed data. The embodiments may provide remote access to the data including the updated data. The embodiments may make the data and/or updated data available in real time. The embodiments may generate and transmit a message based on the data and/or updated data in real time.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by computer readable code. These computer readable code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The computer readable code may also be loaded onto a computer, other programmable data processing apparatus, or other devices to cause a series of operational steps to be performed on the computer, other programmable apparatus, or other devices to produce a computer implemented process such that the program code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and program products according to various embodiments. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable code.

“Doppler-Based Target Tracking and Initial State Estimations using WiFi” by Todd K. Moon and James Hyland is incorporated herein by reference.

A transmitter may employ a WiFi network based on any one of the Institute of Electrical and Electronics Engineers (IEEE) 802.11 standards. The transmitter may also be a mobile telephone network. Alternatively, the transmitter may be a BLUETOOTH® connection. In addition, the transmitter may employ a Radio Frequency Identification (RFID) communication including RFID standards established by the International Organization for Standardization (ISO), the International Electrotechnical Commission (IEC), the American Society for Testing and Materials (ASTM), the DASH7 Alliance, and EPCGlobal.

Alternatively, the transmitter may employ a ZigBee connection based on the IEEE 802standard. Alternatively, the transmitter may be a cellular telephone network communication. All standards and/or connection types include the latest version and revision of the standard and/or connection type as of the filing date of this application.

The problem of locating and tracking a target is one which has been widely explored. For example, in a setting using mobile robots, it is desirable for the robot to know its position, and for devices or humans which interact with the robot to know its position. It may also be desirable to track humans within a building or other space with WiFi. Locating and tracking airplanes has a long history, using for example, any of several different modalities of radar. Geolocation on the earth, using for example the GPS system, is another example of locating.

Several different methods have been developed to perform geolocation. For example, Time of Arrival (TOA) techniques, such as GPS location, make use of signals transmitted from specialized satellites and the time differences from several satellites to the receiver to identify position. This requires a sophisticated satellite infrastructure and precisely controlled timing information. Another method of location, generally referred to as time difference of arrival (TDOA) makes use of time differences of a signal at different receivers. In TDOA, the time difference of a transmitted signal received at two receivers determines a locus of points where the transmitter could be. By employing multiple pairs of transmitters, the transmitter location can be determined. This technique, however, requires precise synchronization between the transmitters. Received signal strength can be used as a method of location. Since the strength of a received signal decreases with the distance from the transmitter, the received signal strength at several receivers can be used to determine the location of a transmitter. Direction of arrival (DOA) methods employ the ability of a receiver to determine the direction from which a transmitted signal arrives, such as using an antenna array. All of these methods require that the target transmit a signal. A different approach to location is to actively query the location of the target using an approach such as radar or (in an acoustic setting) sonar.

The method of the embodiments differs from the techniques summarized above because it does not require the target to transmit any signal, nor does it require active querying as in radar. Instead, the method makes use of radio (or in an acoustic setting, sound) signals already present in the vicinity of the target. These signals might come, for example, from a Wi-Fi transmitter or a radio station. Because this makes use of a signal transmitter at a location different from the receivers, it may be viewed as a form of bi-static radar. However, this does not require that the transmitted signal be designed for particular radar purposes, but may use a variety of incident signals. The method makes use of Doppler changes in the received signal due to motion between the target and the receivers.

An advantage of the embodiments is that they do not require that the receivers by closely synchronized. While information is shared among the receivers to estimate position and velocity of the target, this does not require the very tight synchronization required by other methods such as TOA and TDOA. Receiver share Doppler information, synchronized to within the target tracking requirements of the system, and not to within the timing requirements to estimate, for example, phase differences between receivers.

An additional advantage of this system is that it can take advantage of existing signals, without requiring additional signaling for purposes of tracking. For example, in a mobile robot setting, it is not required that specialized signals be provided for location-communication infrastructure within the region can put to dual use for location as well.

A further advantage of this system is that it may operate covertly. It may be desirable to locate and track a target without the target being aware that it is being tracked, for example in a surveillance application. The target may not be transmitting, and any signal directed toward the target (e.g., radar), may enable the target to learn that its motion is being tracked. By making use of incidental radio signals in the area, surveillance tracking is possible without an indication to the target that it is being tracked.

The embodiments may be used in a variety of settings. For example, it may be used within a building to track moving targets, such as mobile robots or persons within the building. It may also be used on the scale of a city or an airspace to track targets such as vehicles or aircraft. In another application, the target may be fixed, with the transmitters and receivers are moving relative to the target.

For convenience, positions and velocities are described using two-dimensional coordinates. However, the embodiments may be generalized to three-dimensional coordinates when a target is moving with three positional degrees of freedom.

In many applications, the transmitters will be fixed, such as WiFi routers or commercial radio transmitters. But the embodiments also encompasses the situation where the transmitters are moving relative to the target.

Multiple transmitters can be advantageously accommodated when the signals that they transmit are, for example, bandpass signals occurring in different bands. The receivers can separately receive the signal from each transmitter in this case by performing complex basebanding using a carrier appropriate for the band in which the transmitter is transmitting.

The description of elements in each figure may refer to elements of proceeding figures. Like numbers refer to like elements in all figures, including alternate embodiments of like elements.

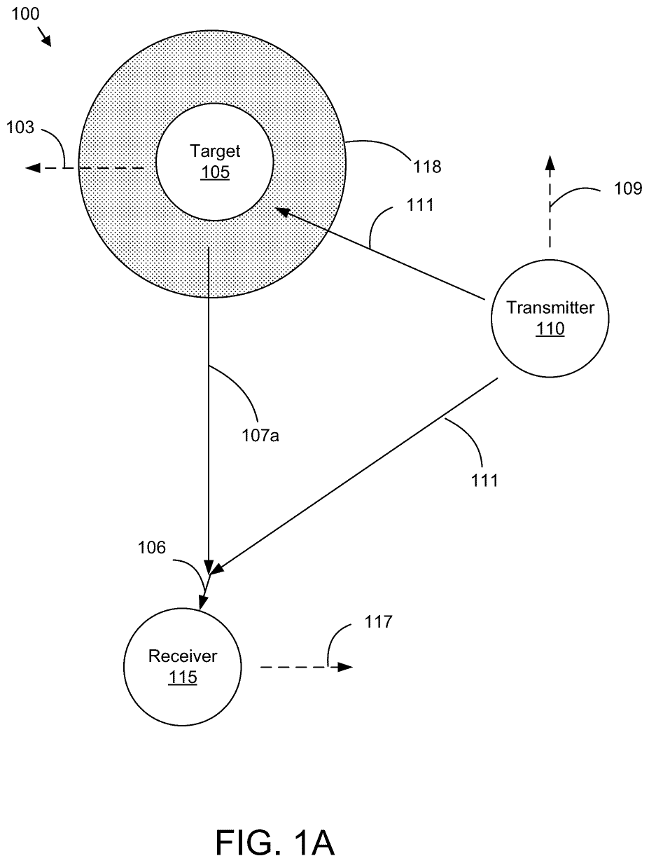

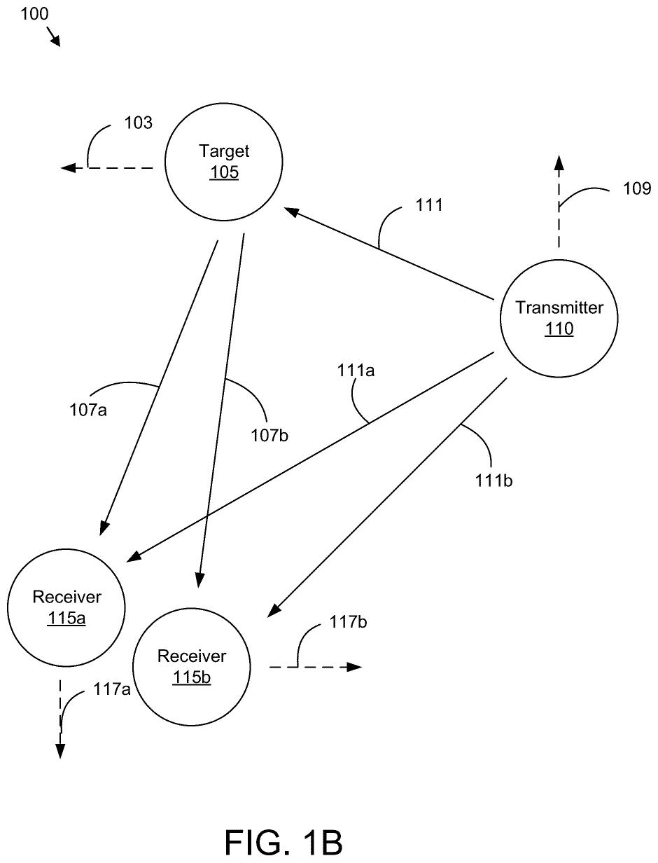

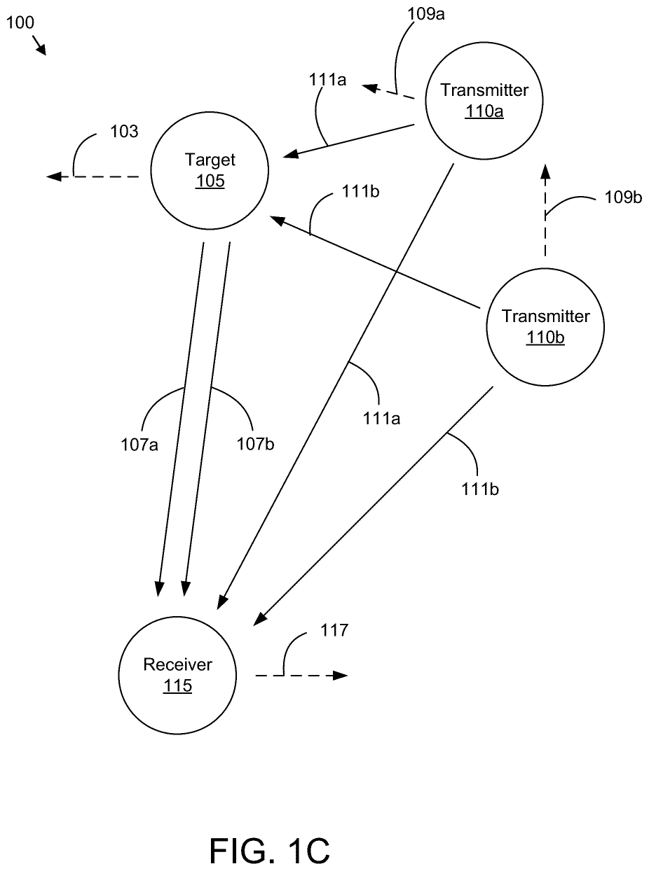

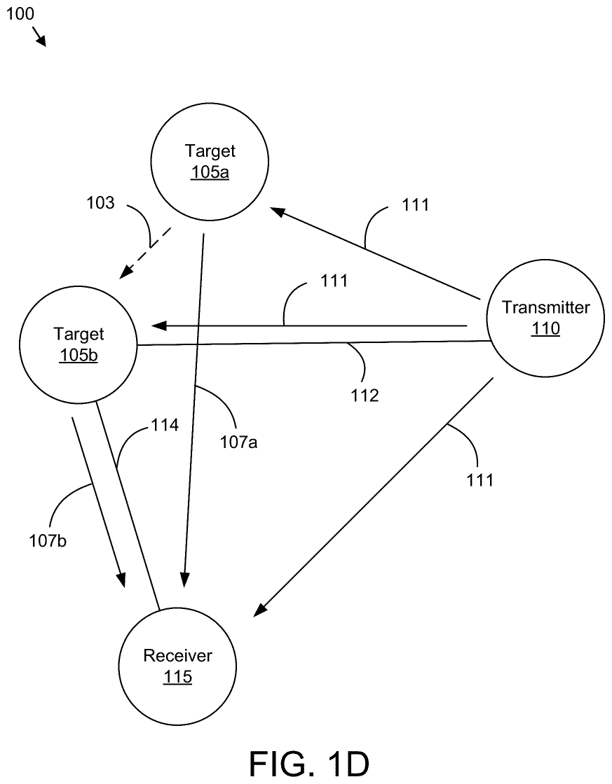

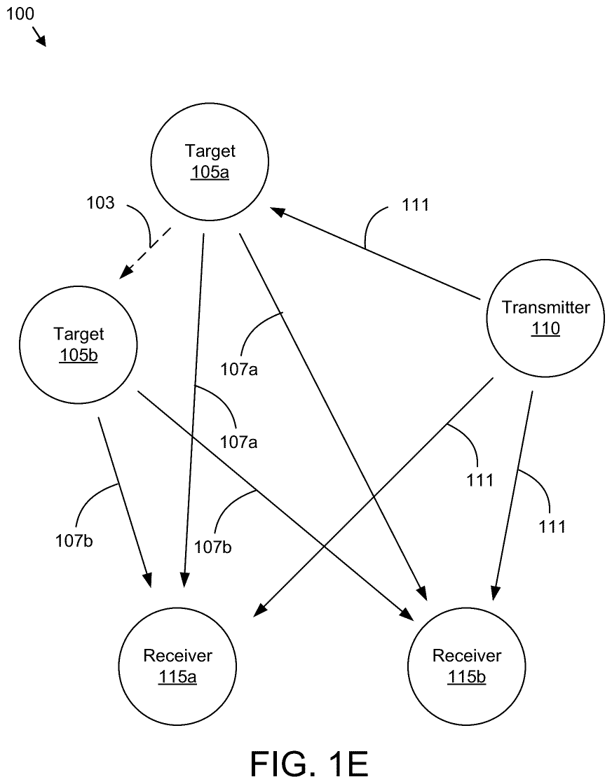

FIG. 1A is a schematic block diagram illustrating one embodiment of a target system 100. The system 100 includes a target 105, at least one transmitter 110, and at least one receiver 115. The target 105 may be in motion with a target velocity vector 103. The transmitter 110 may be in motion with transmitter velocity vector 109. The receiver 115 may be in motion with the receiver velocity vector 117.

The transmitter 110 may broadcast a transmitter signal 111. The transmitter signal 111 may be reflected by the target 105 as a target signal 107. The receiver 115 may receive the target signal 107. The receiver 115 may also receive the transmitter signal 111. The receiver 115 may receive the target signal 107 and the transmitter signal 111 as a combined signal 106.

In one embodiment, a field of interest 118 is defined for the target 105. The field of interest 118 may be within a specified radius of the target 105.

FIG. 1B is a schematic block diagram illustrating one alternate embodiment of the target system 100. In the depicted embodiment, two receivers 115 are shown. Each receiver 115a-b may have a unique receiver velocity vector 117a-b. Although two receivers 115a-b are shown, any number of receivers 115 may be employed. In one embodiment, at least three receivers 115 are employed.

FIG. 1C is a schematic block diagram illustrating one alternate embodiment of a target system 100. In the depicted embodiment, two transmitters 110a-b are shown. Each transmitter 110a-b may have a unique transmitter velocity vector 109a-b. Although two transmitters 110a-b are shown, any number of transmitters 110 may be employed. In one embodiment, at least three transmitters 110 are employed.

FIG. 1D is a schematic diagram illustrating one embodiment of a target system 100. In the depicted embodiment, two targets 105a-b are shown. Each target 105a-b has a corresponding target signal 107a-b that is received by the receiver 115. Although two targets 105 are shown, any number of targets 105 may be tracked. A unit vector 112 from the transmitter 110 to the target 105b and a unit vector 114 from the target 105b to the receiver 115 are also shown.

FIG. 1E is a schematic diagram illustrating one alternate embodiment of a target system 100. In the depicted embodiment, two targets 105a-b and two receivers 115a-b are shown. Each receiver 115a-b receives a target signal 107a-b from each target 105a-b. Although one transmitter 110, two targets 105a-b, and two receivers 115a-b are shown, any number of transmitters 110, targets 105, and/or receivers 115 may be employed.

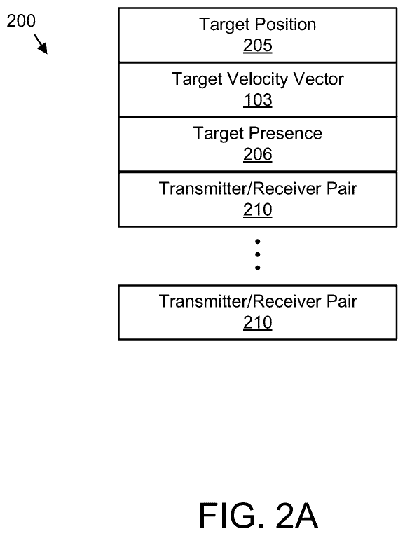

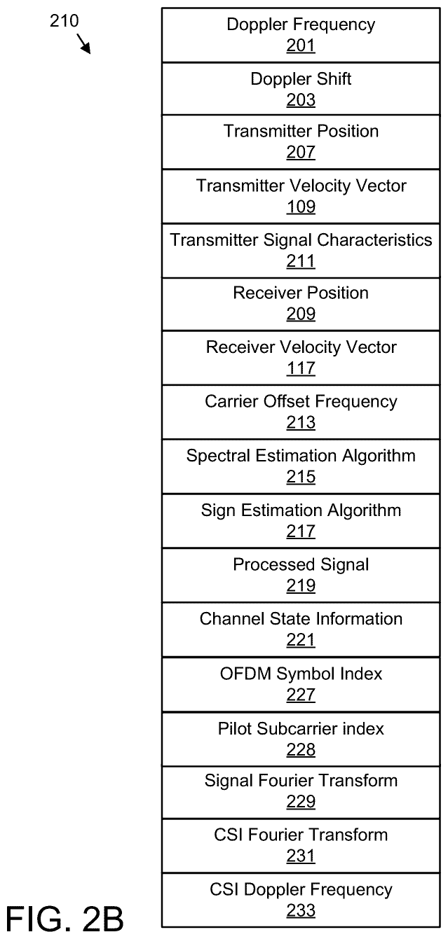

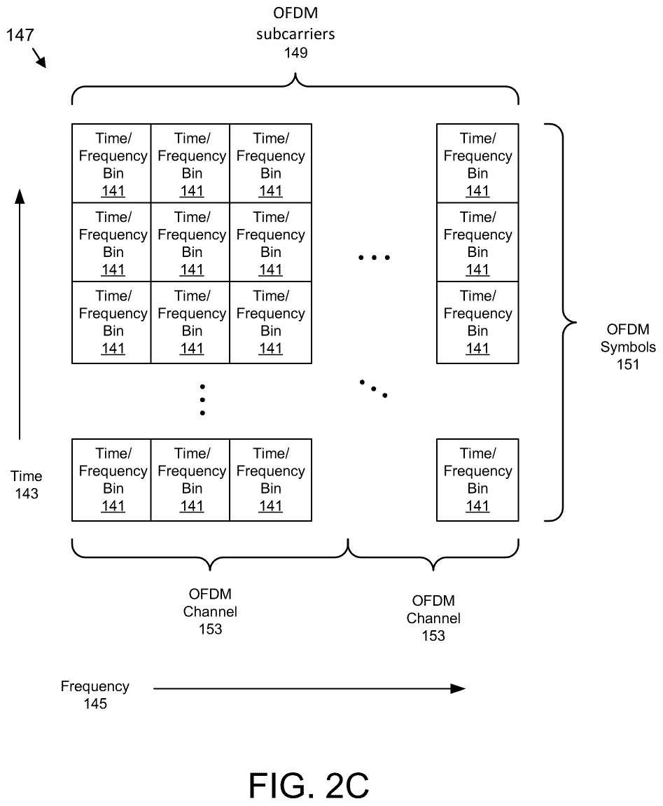

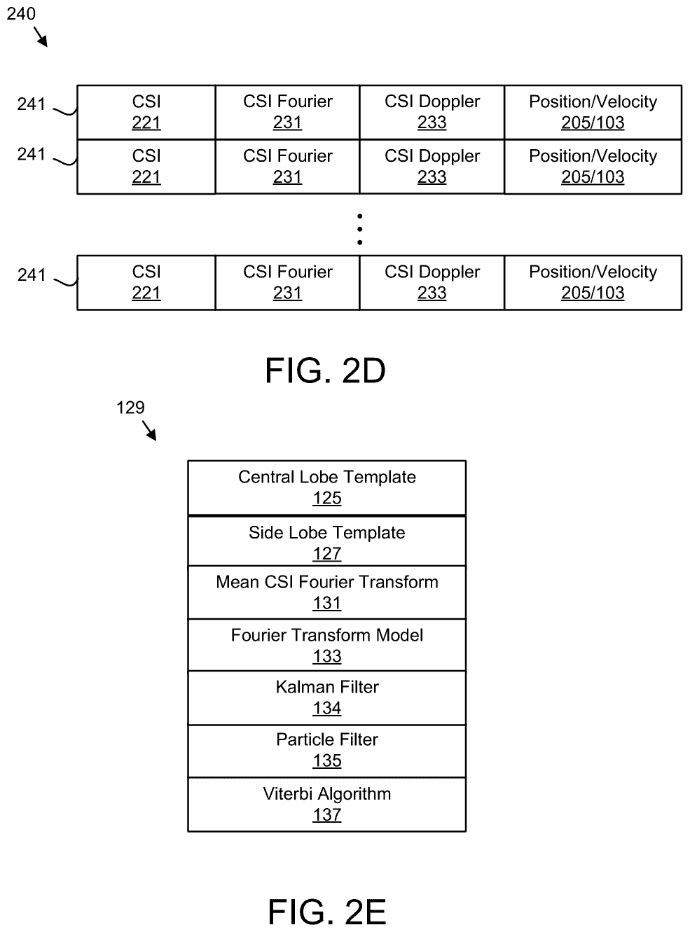

FIG. 2A is a schematic block diagram illustrating one embodiment of Doppler information 200. The Doppler information 200 may be organized a data structure in a memory. In the depicted embodiment, the Doppler information 200 includes a target position 205, the target velocity vector 103, a target presence 206, and one or more transmitter/receiver pairs 210.

The target position 205 and/or target velocity vector 103 and/or target presence 206 may be calculated for each target 105 as will be described hereafter. Each transmitter/receiver pair 210 may record data for a transmitter 110 and a receiver 115. The transmitter/receiver pair 210 is described in more detail in FIG. 2B.

FIG. 2B is a schematic block diagram illustrating one embodiment of a transmitter/receiver pair 210. In the depicted embodiment, the transmitter/receiver pair 210 includes a Doppler frequency 201, a Doppler shift 203, the transmitter position 207, the transmitter velocity vector 109, transmitter signal characteristics 211, a receiver position 209, the receiver velocity vector 117, a carrier offset frequency 213, a spectral estimation algorithm 215, a sign estimation algorithm 217, a processed signal 219, channel state information (CSI) 221, an OFDM symbol index 227, a pilot subcarrier index 228, a signal Fourier transform 229, a CSI Fourier transform 231, and a CSI Doppler frequency 233.

The Doppler frequency 201 may be a frequency of a Doppler shift 203 of a target signal 107. The Doppler frequency 201 may be calculated as will be described hereafter. The Doppler shift 203 may be a change in frequency from a transmitter signal 111 to a target signal 107 and/or combined signal 106.

The transmitter position 207 identifies a spatial position of the transmitter 110 of the transmitter 110/receiver 105 pair. The transmitter velocity vector 109 is a vector describing the change of position of the transmitter 110. The transmitter signal characteristics 211 may describe a frequency of the transmitter signal 111, a strength of the transmitter signal 111, and the like.

The receiver position 209 identifies a spatial position of the receiver 104. The receiver velocity vector 117 describes the change of position of the receiver 105. The carrier offset frequency 213 may be calculated for each target signal 107.

The spectral estimation algorithm 215 may be selected from the group consisting of a Multiple Signal Classification (MUSIC) algorithm, a Discrete Fourier Transform (DFT) algorithm, a Viterbi algorithm, a Bahl, Cocke, Jelinek and Raviv (BCJR) algorithm, and a BCJR algorithm in conjunction with the Viterbi algorithm.

The sign estimation algorithm 217 may estimate a sign of the Doppler frequency 201. The sign estimation algorithm 217 may be a maximum likelihood algorithm. The processed signal 219 may have a DC component, and a frequency component fa as will be described hereafter.

The CSI 221 may include information for a plurality of OFDM carrier signals. The OFDM carrier signals are described in FIG. 2C. The OFDM symbol index 227 indexes a plurality of OFDM carrier signals. The pilot subcarrier index 228 may comprise pilot indices pilot (n) for each OFDM subcarrier signal n. The signal Fourier transform 229 is a Fourier transform of the combined signal 106. The CSI Fourier transform 231 is a Fourier transform of the CSI 221. The CSI Doppler frequency 233 comprises Doppler frequencies estimated from the CSI Fourier transform 231.

FIG. 2C is a schematic block diagram illustrating OFDM carrier signals 147. In the depicted embodiment, a plurality of OFDM subcarriers 149 comprise a plurality of OFDM channels 153 each with a different range of frequencies 145. The OFDM channels 153 comprises a plurality of time/frequency bins 141. Each time/frequency then 141 encodes specified information as OFDM symbols 151 and is separated from each other time/frequency pin 141 in both time 143 and frequency 145.

FIG. 2D is a schematic block diagram illustrating one embodiment of a data sequence 240. The data sequence 240 may be generated from a sequence of combined signals 106 over time. In the depicted embodiment, each entry 241 of the data sequence 240 includes CSI 221, a CSI Fourier transform 231, a CSI Doppler frequency 233, and the position 205 and/or velocity 103 for each target 105.

FIG. 2E is a schematic block diagram illustrating one embodiment of functions 129. The functions 129 may be organized as a data structure in a memory. The Fourier transform templates 129 may model a CSI Fourier transform 231. In the depicted embodiment, the Fourier transform templates 129 includes a central lobe template 125 and decide lobe template 127. In one embodiment, the CSI Doppler frequency 233 is estimated by matching the Fourier transform templates 129 to the CSI Fourier transform 231.

In one embodiment, a mean CSI Fourier transform 131 is estimated by averaging the CSI Fourier transform 231 of the CSI 221 over at least one OFDM subcarriers 149. In one embodiment, a Fourier transform model 133 is trained match Fourier Transforms as will be described hereafter. In a certain embodiment, a Kalman filter 134 and/or a particle filter 135 are included. The Kalman filter 134 may comprise a model of the target system 100 and/or a target 105. The particle filter 135 may comprise a plurality of particles representing target positions 205 and a model of behavior of the targets 105.

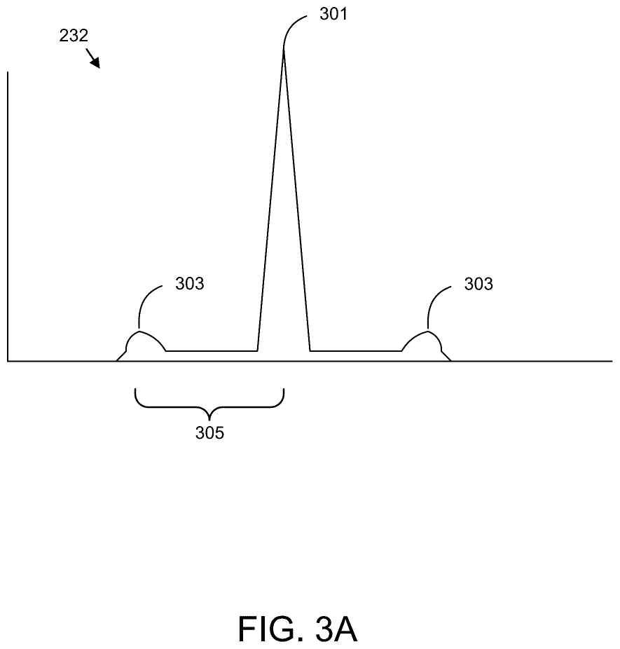

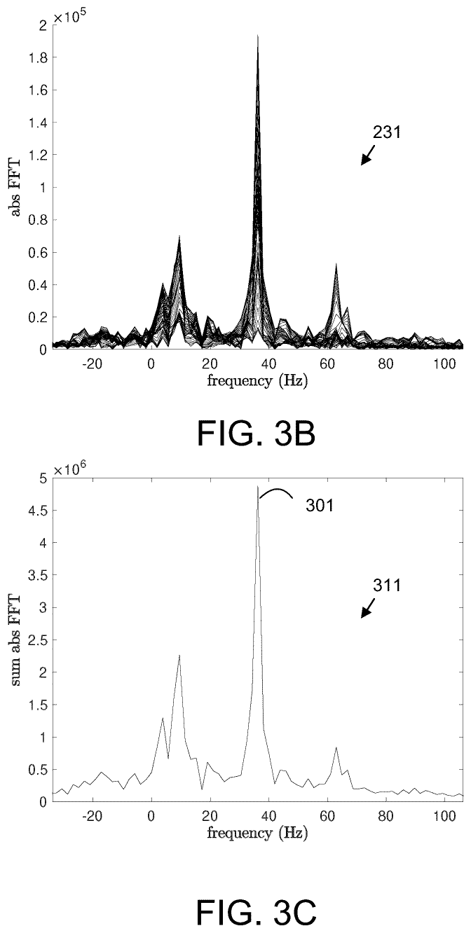

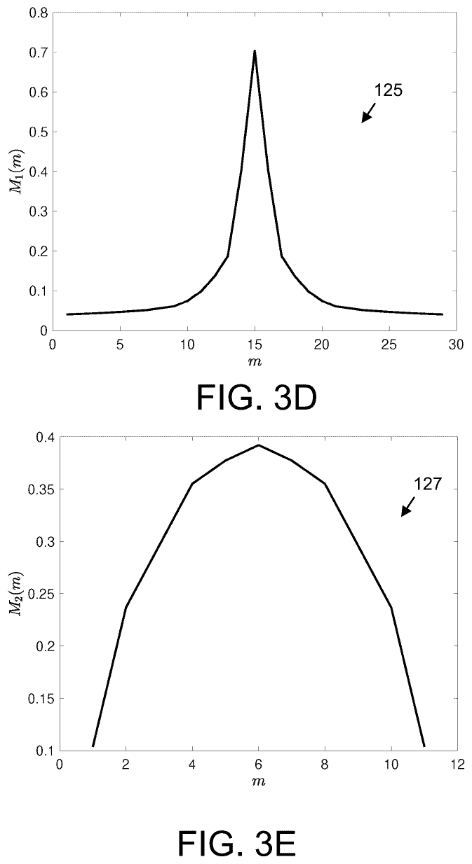

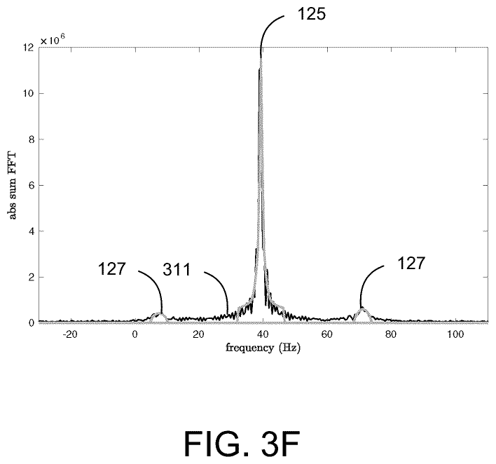

FIG. 3A is a diagram illustrating one embodiment of a Fourier transform 232. The Fourier transform 232 may be the CSI Fourier transform 231. Alternatively, the Fourier transform 232 may be the signal Fourier transform 229. In the depicted embodiment, the Fourier transform 232 includes a central lobe 301 and at least one side lobe 303. A side lobe 303 may be separated from the center lobe 301 by a frequency interval 305. The frequency interval 305 may be measured, calculated, and/or estimated.

FIG. 3B is a graph illustrating one embodiment of CSI Fourier transforms 231. A plurality of CSI Fourier transforms 231 for a plurality of CSI 221 are shown.

FIG. 3C is a graph illustrating one embodiment of a Fourier transform sum 311. A Fourier transform sum 311 of the Fourier transforms 231 of FIG. 3B is shown. The central lobe 301 of the Fourier transform sum 311 is shown.

FIG. 3D is a graph illustrating one embodiment of a central lobe template 125. The central lobe template 125 matches the central lobe 301 of the Fourier transform sum 311 of FIG. 3C.

FIG. 3E is a graph illustrating one embodiment of a side lobe template 127. The side lobe template 127 matches the side lobe 303 of the Fourier transform sum 311 of FIG. 3C.

FIG. 3F is a graph illustrating one embodiment of template matching. In the depicted embodiment, the central lobe template 125 and/or side lobe templates 127 are matched to the CSI Doppler frequency 233 and/or Fourier transform sum 311. In the depicted embodiment, the match indicates that the target 105 is moving forward.

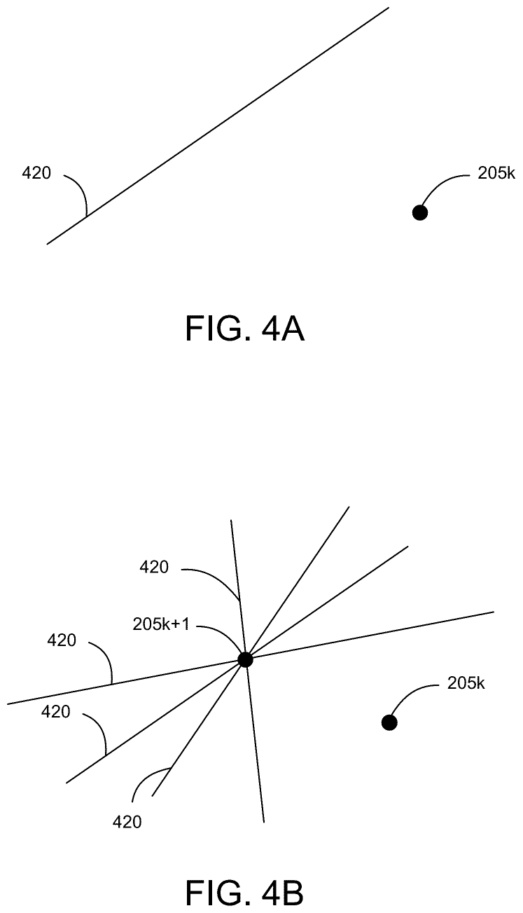

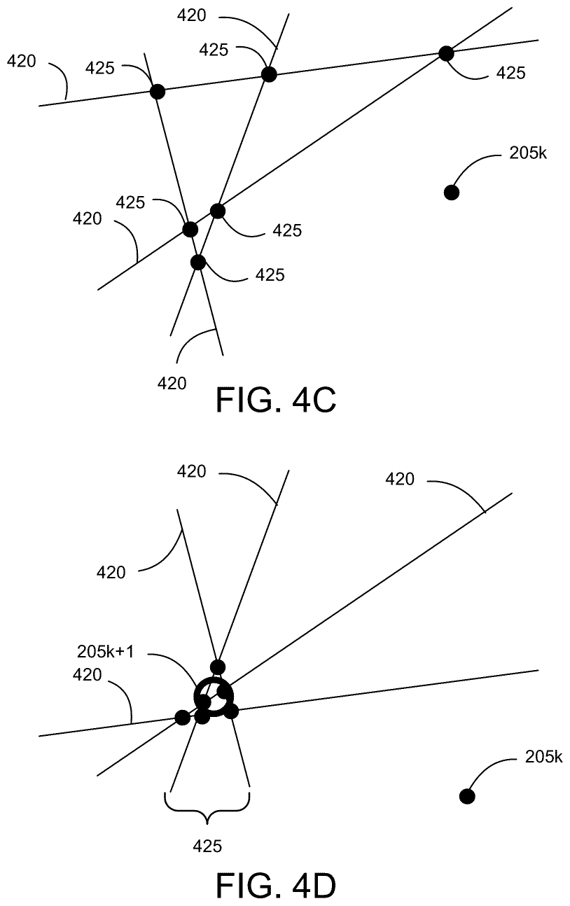

FIG. 4A is a drawing illustrating one embodiment of a position line 420. The position line 420 describes all positions that are reachable from a current target position 205k due to velocities that are consistent with a measurement of a CSI Doppler frequency f_{a,j,k} 233 for a given transmitter/receiver pair j 210 and a given time step k. Possible y coordinates of a next target position 205k+1 may be calculated using Equations 1-5 wherein k specifies a given time step, j specifies a given transmitter/receiver pair 210, the current target position 205k is (xₖ, yₖ), x_{T} and y_{T} are coordinates for a Transmitter T 110, u_{T,k} is a unit vector 112 for time step k from the target 105 to the transmitter T 110, U_{R,j,k} is a unit vector 114 from a target 105 to a receiver R 115 for transmitter 110/receiver 115 pair j for time step k with noise, m_{j,k} is a slope, b_{j,k} is an offset.

$${u}_{T , k} = \frac{( {x}_{k} , {y}_{k} ) - ( {x}_{T} , {y}_{T} )}{‖ ( {x}_{k} , {y}_{k} ) - ( {x}_{T} , {y}_{T} ) ‖} \qquad Eq . 1$$

$${u}_{R , j , k} = \frac{( {x}_{k} , {y}_{k} ) - ( {x}_{T} , {y}_{T} )}{‖ ( {x}_{k} , {y}_{k} ) - ( {x}_{T} , {y}_{T} ) ‖} \qquad Eq . 2$$

$${u}_{j , k} = {u}_{T , k} + {u}_{R , j , k} = ( {u}_{x , j , k} , {u}_{y , j , j} ) \qquad Eq . 3$$

$${m}_{j , k} = \frac{{u}_{x , j , k}}{{u}_{y , j , k}} \qquad Eq . 4$$

$${b}_{j , k} = \frac{{u}_{x , j , k}}{{u}_{y , j , k}} {x}_{k} + {y}_{k} - \frac{{Δ}_{T} {cf}_{d , j , k}}{{f}_{c} {u}_{y , j , k}} \qquad Eq . 5$$

The position line 420 is generated for possible x coordinate positions x_{poss,j,k+1} and possible y coordinate positions y_{poss,j,k+1} of the next target position 205k+1 for a measured Doppler frequency 201 as shown in Equation 6.

$${y}_{poss , j , k + 1} = {m}_{j , k} {x}_{pos , j , k + 1} + {b}_{j , k} \qquad Eq . 6$$

FIG. 4B is a drawing illustrating one embodiment of position lines 420. Each position line 420 is computed for a measurement of a Doppler frequency 201 for a transmitter/receiver pair j 210. In the depicted embodiment, four position lines 420 computed from four measurements of a Doppler frequency 201 for a transmitter/receiver pair 210 without noise are shown. At least three Doppler frequencies 201 may be employed.

FIG. 4C is a drawing illustrating one embodiment of position intersections 425. In the depicted embodiment, four position lines 420 are shown for Doppler frequencies 201 for four transmitter/receiver pairs 210. The position lines 420 intersect at position intersections 425. Because the position intersections 425 are scattered, the current target position 205k is not an accurate position for the target 105. In one embodiment, the scattering is computed as one of a standard deviation, a variance, an interquartile range, and a mean absolute deviation.

FIG. 4D is a drawing illustrating one embodiment of position intersections 425 and a target position 205k. Because the position intersections 425 are clustered relatively close together when the postulated target position 205k+1 is the correct target position 205, the current target position 205k can be used as an estimate for the correct target position 205. A target position 205k with the most closely spaced position intersections 425 may be selected.

A next target position 205k+1 is shown. Because the target position 205k is accurate, a next target position 205k+1 may be computed more accurately. The next target position 205k+1 may be computed as a least sum of squares solution for the position intersections 425. In a certain embodiment, the next target position \hat{x}ₖ₊₁ 205k+1 is computed as an approximation as shown in Equations 7-10, wherein Aₖ ⁵⁵⁴ is a pseudoinverse (A^{T}A)⁻¹A^{T}.

$${A}_{k} = [ \begin{matrix}{m}_{1 , k} & - 1 \\ ⋮ & ⋮ \\ {m}_{J , k} & - 1\end{matrix} ] \qquad Eq . 7$$

$${b}_{k} = [ \begin{matrix}- {b}_{1 , k} \\ ⋮ \\ - {b}_{n , k}\end{matrix} ] \qquad Eq . 8$$

$${A}_{k} [ \begin{matrix}{\hat{x}}_{k + 1} \\ {\hat{y}}_{k + 1}\end{matrix} ] = {b}_{k} + noise \qquad Eq . 9$$

$${\hat{x}}_{k + 1} = [ \begin{matrix}{\hat{x}}_{k + 1} \\ {\hat{y}}_{k + 1}\end{matrix} ] = {A}_{k}^{†} {b}_{k} \qquad Eq . 10$$

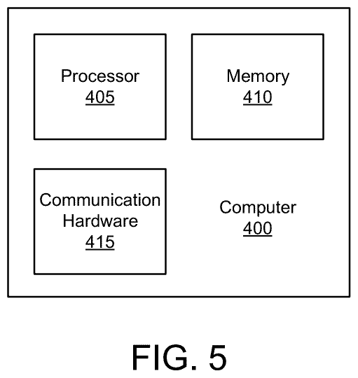

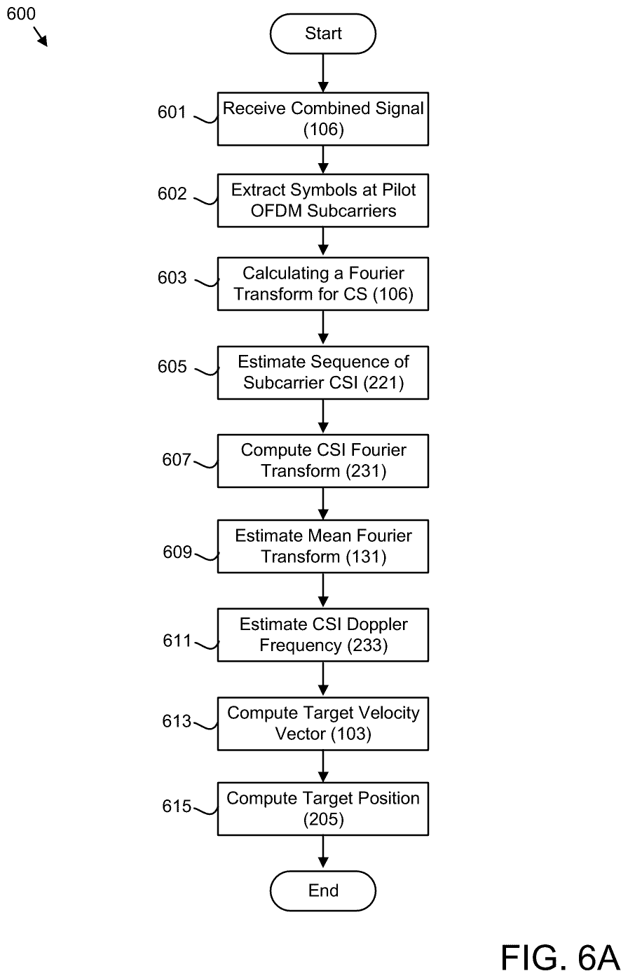

FIG. 5 is a schematic block diagram illustrating one embodiment of a computer 400. In the depicted embodiment, the computer 400 includes a processor 405, a memory 410, and communication hardware 415. The memory 410 may include a semiconductor storage device, a hard disk drive, an optical storage device, or combinations thereof. The memory 410 may store code. The processor 405 may execute the code. The communication hardware 415 may communicate with other devices such as the receiver 115.

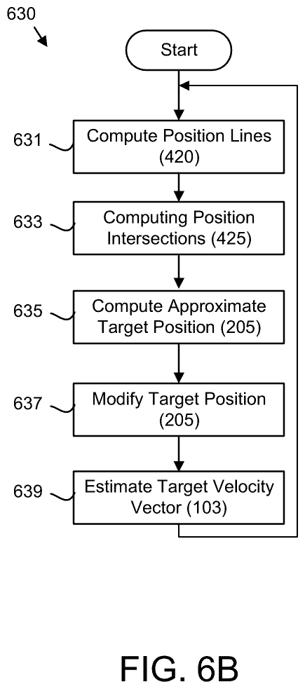

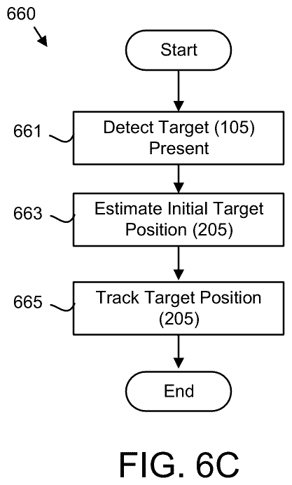

FIG. 6A is a schematic flow chart diagram illustrating one embodiment of a tracking method 600. The method 600 may be performed by the processor 405. The processor 405 may receive 501 the combined signal 106 comprising the target signals 107 and transmitter signals 111 and compute a target position 205 and the target velocity vector 103 for the target 105.

The method 600 starts, and in one embodiment, the processor 405 receives 601 the combined signal 106. In one embodiment, a target signal 107 is received from each of the receivers 115. The combined signal 106 includes the target signal 107 reflected by at least one target 105 and at least one transmitter signal 111 not reflected by the target 105. The at least one transmitter signal 111 may be comprised of a plurality of OFDM subcarrier signals 147.

The processor 405 extracts symbols at the pilot OFDM subcarrier signals 147. The CSI 221 may be estimated at the pilots.

The processor 405 may calculate 603 the signal Fourier transform 229 for the combined signal 106 such as is shown in FIG. 3A. In one embodiment, pilot signals of the transmitter signal 111 are used to separate OFDM subcarriers 149 to obtain the complex symbols zₘ[n], where n is the pilot subcarrier index 227, and m is the OFDM symbol index 227.

The processor 405 may estimate 605 a sequence of ĉ_{m,n} for known pilot signals of the OFDM subcarrier signals 147 of the combined signal 106 and interpolate across the CSI 221 to estimate the CSI 221 at each OFDM subcarrier signal 147 using Equation 11. Because the estimation 605 is peformed in real time, the step is not practically performed by the human mind. The sequence of CSI ĉ_{m,n} 221 may be recorded in the data sequence 240. m n

$${\hat{c}}_{m , n} = ( \frac{{z}_{m} [ n ]}{{pilot}_{m} ( n )} ) \qquad Eq . 11$$

In one embodiment, the OFDM symbols 151 transmitted on OFDM subcarrier signals â_{m,n} 147 are estimated using Equation 12, wherein

$$Q ( \frac{{z}_{m} [ n ]}{{\hat{c}}_{m , n}} )$$

represents quantizing

$$( \frac{{z}_{m} [ n ]}{{\hat{c}}_{m , n}} )$$

to a nearest point in the signal space and where c_{m,n} is the estimated CSI 221.

$${\hat{a}}_{m , n} = Q ( \frac{{z}_{m} [ n ]}{{\hat{c}}_{m , n}} ) \qquad Eq . 12$$

The processor 405 may further estimate 605 a sequence of CSI 221 over the non-pilot OFDM subcarriers 149 of the OFDM subcarrier signals 147 of the combined signal 106 such as is shown in FIG. 3B. In one embodiment, the CSI 221 for the non-pilot OFDM subcarriers 149 is interpolated from the CSI 221 for the pilot indices. As a result, the processor 405 may obtain CSI 221 for a sequence of M OFDM symbols 151.

The processor 405 may compute 607 the CSI Fourier transform 231 for the sequence of CSI 221 for the plurality of OFDM subcarriers 149 such as shown in FIG. 3B. Because the computation 607 is peformed in real time, the step is not practically performed by the human mind. The CSI Fourier transforms 231 may be recorded in the data sequence 240 with the corresponding CSI 221.

The processor 405 may estimate 609 the mean Fourier transform 131 such as is shown in FIG. 3C. In one embodiment, the mean Fourier transform 131 is estimated by averaging the CSI Fourier transform 231 of the CSI 221 over at least one OFDM subcarrier 149. Because the estimation 609 is peformed in real time, the step is not practically performed by the human mind.

The processor 405 may estimate 611 the CSI Doppler frequency 233. In one embodiment, the CSI Doppler frequency 233 is estimated 611 by matching a Fourier transform template 129 to the CSI Fourier transform 231. The central lobe template 125 may be matched to a central lobe 301 as shown in FIG. 3C of the CSI Fourier transform 231 indicating stationary components. In one embodiment the central lobe 301 is offset by a carrier offset frequency. In addition, the side lobe template 127 may be matched to side lobes 303 of the Fourier transform 232, indicative of Doppler frequency components. In a certain embodiment, the Fourier transform template 129 may match the CSI Fourier transform 231 if the frequency interval 305 of the Fourier transform template 129 is within a frequency threshold of the frequency interval 305 of the CSI Fourier transform 231. Because the estimation 611 is peformed in real time, the step is not practically performed by the human mind. The CSI Doppler frequency 233 may be recorded in the data sequence 240 with the corresponding CSI Fourier transform 231.

In one embodiment, the CSI Doppler frequency 233 is calculated using a complex ambiguity function. In addition, the CSI Doppler frequency 233 may be refined using a Viterbi algorithm.

In one embodiment, the CSI Doppler frequency 233 is estimated 611 using the Fourier transform model 133. The Fourier transform model 133 may be trained a data set comprising Fourier transform templates 129 and CSI Fourier transforms 231, with matches and no matches indicated in the data set.

In one embodiment, the CSI Doppler frequency r 233 is calculated from the delays τ₁ and τ₂ which minimize Equation 13.

$$r ( {τ}_{1} , {τ}_{2} ) = {f}^{T} f - R ( {τ}_{1} , {τ}_{2} ) = {f}^{T} {P}_{M ( {τ}_{1} , {τ}_{2} )} f \qquad Eq . 13$$

Wherein f the spectrum of the CSI 221 is determined from Equation 14.

$$f = [ \begin{matrix}F ( {T}_{1} ) \\ F ( {T}_{1} + 1 ) \\ ⋮ \\ F ( {T}_{2} )\end{matrix} ] \qquad Eq . 14$$

R(τ₁, τ₂) is the compressed likelihood expressed in Equation 15.

$$R ( {τ}_{1} , {τ}_{2} ) {=}^{T} ( I - {{M ( {τ}_{1} , {τ}_{2} )}^{T} [ {M ( {τ}_{1} , {τ}_{2} )}^{T} M ( {τ}_{1} , {τ}_{2} ) ]}^{- 1} ) \qquad Eq . 15$$

P_{M(τ}_{_{1, τdi 2)}} is the matrix which projects onto the range of the matrix M(τ₁, τ₂), where M(τ₁, τ₂) is given by Equation 16.

$$M ( {τ}_{1} , {τ}_{2} ) = [ {m}_{1} ( {τ}_{1} ) {m}_{2} ( {τ}_{1} {τ}_{2} ) {m}_{1} ( {τ}_{1} {τ}_{2} ) ] \qquad Eq . 16$$

And where m₁(τ₁11), m₂(τ₁, τ₂) represent the shifted templates described by Equations

17-19.

$${m}_{1} ( {τ}_{1} ) = [ \begin{matrix}{M}_{1} ( {T}_{1} − {τ}_{1} ) \\ {M}_{1} ( {T}_{1} + 1 − {τ}_{1} ) \\ ⋮ \\ {M}_{1} ( {T}_{2} )\end{matrix} ] \qquad Eq . 17$$

$${m}_{2} ( {τ}_{1} , {τ}_{2} ) = [ \begin{matrix}{M}_{2} ( {T}_{1} − ( {τ}_{1} + {τ}_{2} ) ) \\ {M}_{2} ( {T}_{1} + 1 − ( {τ}_{1} + {τ}_{2} ) ) \\ ⋮ \\ {M}_{2} ( {T}_{2} − ( {τ}_{1} + {τ}_{2} ) )\end{matrix} ] \qquad Eq . 18$$

$${m}_{3} ( {τ}_{1} , {τ}_{2} ) = [ \begin{matrix}{M}_{2} ( {T}_{1} − ( {τ}_{1} − {τ}_{2} ) ) \\ {M}_{2} ( {T}_{1} + 1 − ( {τ}_{1} − {τ}_{2} ) ) \\ ⋮ \\ {M}_{2} ( {T}_{2} − ( {τ}_{1} − {τ}_{2} ) )\end{matrix} ] \qquad Eq . 19$$

The processor 405 may compute 613 the target position 205 for the target 105 from the CSI Doppler frequency 233. In one embodiment, the target position 205 is computed 613 within the field of interest 118. The processor 405 may further compute 615 the target position 205 for the target 105 and the method 600 ends. The dynamics for the target 105 may be computed based on a Singer model. Because the computations 613/615 are peformed in real time, the steps are not practically performed by the human mind. The target position 205 may be computed 615 within the field of interest 118.

In one embodiment, target position 205 and/or the target velocity vector 103 are determined based on Equation 20, wherein f_{d,i,j} denotes Doppler frequency determined at receiver j from a signal transmitted at transmitter i, and wherein x(t) and y(t) are a position of the target 105 at time t, x_{R,j}(t) and y_{R,j}(t) are a position of a receiver j 115 at time t, x_{T,i}(t) and Y_{T,i}(t) are a position of a transmitter i (110) at time t, vₓ(t) and vᵥ(t) are a velocity of the target 105 at the time t, f_{c} is a carrier frequency of the combined signal 106.

$${f}_{d , i , j} ( x ( t ) , y ( t ) , {v}_{x} ( t ) , {v}_{y} ( t ) ) = − \frac{{f}_{c}}{c} [ ( {v}_{x} ( t ) , {v}_{y} ( t ) ) \cdot ( {\frac{( x ( t ) , y ( t ) ) − ( {x}_{T , i} ( t ) , {y}_{T , i} ( t ) )}{‖ ( x ( t ) , y ( t ) ) − ( {x}_{T , i} ( t ) , {y}_{T , i} ( t ) ‖} + \atop \frac{( x ( t ) , y ( t ) ) − ( {x}_{R , j} ( t ) , {y}_{R , j} ( t ) )}{‖ ( x ( t ) , y ( t ) ) − ( {x}_{R , j} ( t ) , {y}_{R , j} ( t ) ‖}} ) - ( {v}_{T , i , x} ( t ) , {v}_{T , i , y} ( t ) ) \cdot \frac{( x ( t ) , y ( t ) − ( {x}_{T , i} ( t ) , {y}_{T , i} ( t ) )}{‖ ( x ( t ) , y ( t ) ) − ( {x}_{T , i} ( t ) , {y}_{T , i} ( t ) ) ‖} - ( {v}_{R , j , x} ( t ) , {v}_{R , j , y} ( t ) ) \cdot \frac{( x ( t ) , y ( t ) ) − ( {x}_{R , j} ( t ) , {y}_{R , j} ( t ) )}{‖ ( x ( t ) , y ( t ) ) − ( {x}_{R , j} ( t ) , {y}_{R , j} ( t ) ) ‖} ] \qquad Eq . 20$$

$$i = 1 , 2 , … , I , j = 1 , 2 , … , J .$$

The embodiments use the mathematical formulas and calculations in a specific manner that limits the use of the mathematical concepts to the practical application of computing the target position 205 and computing the target velocity vector 103. Thus, the mathematical concepts are integrated into a process that provides position and motion information for the target 105.

FIG. 6B is a schematic flow chart diagram illustrating one embodiment of a target position estimation method 630. The method 630 computes an approximate target position 205. In addition, the method 630 may estimate a target velocity vector 103. The method 600 may be performed by the processor 405.

The method 630 starts and the processor 405 computes 631 position lines 420 of potential target positions 205k+1 reachable from a target position 205. The potential target positions 205k+1 may be computed using method 600 of FIG. 6A. In a certain embodiment, the potential target positions 205k+1 are based on a target velocity vector 103 for at least three measurements of CSI Doppler frequency 233 based on a sequence of CSI 221. The target position 205 may be a current target position 205. In one embodiment, initial values within a space may be selected for the target position 205 and/or target velocity vector 103. The accuracy of the initial values may be low, but accuracy of the target position 205 and/or target velocity vector 103 may be subsequently improved.

The processor 405 computes 633 position intersections 425 of the position lines 420. The position intersections 425 may be computed 633 as illustrated in FIG. 4C. In addition, the method 630 computes 635 an approximate target position 205 as the target position 205 with the most closely spaced position intersections 425 such as is illustrated in FIG. 4D.

The processor 405 may modify 637 the approximate target position 205. The target position 205 may be modified 637 as illustrated in FIG. 4D. The target position 205 may be modified 637 to a least sum of squares solution for the position intersections 425.

In one embodiment, the processor 405 estimates 639 the target velocity vector 103. The target velocity vector 103 may be estimated 639 based on at least the next target position 205k+1 and the current target position 205k. In a certain embodiment, previous target positions 205k−n may also be employed.

FIG. 6C is a schematic flow chart diagram illustrating one embodiment of a target tracking method 660. The method 660 tracks a target 105. The method 660 may be performed by the processor 405.

The method 660 starts and the processor 405 detects 661 that a target 105 is present. The target 105 may be detected 661 by detecting a change in a CSI 221. In addition, the target 105 may be detected 661 using the method 600 of FIG. 6A.

The processor 405 estimates 663 an initial target position 205. The initial target position 205 may be estimated 663 using the method 600 of FIG. 6A.

The processor 405 further tracks 665 the target position 205. The target position 205 may be tracked using the method 600 of FIG. 6A. In one embodiment, the target position 205 is modified using the method 630 of FIG. 6B. In one embodiment, the position line 420 is identified based on the CSI Doppler frequency (233) using a Viterbi algorithm. In addition, points on the position line 420 may computed using a branch metric ∥ (xₙₑₓₜ, yₙₑₓₜ)-(xₙₑₐᵣ, yₙₑₐᵣ) 112 for each receiver 115 wherein xₙₑₓₜ and yₙₑₓₜ are coordinates of a next point on the position line 420 and xₙₑₐᵣ and yₙₑₐᵣ are coordinates of a near point to the next point.

In one embodiment, a target track of the target 105 may be estimated using an extended Kalman filter 134. In a certain embodiment, the target track may be estimated based on a CSI Doppler frequency 233 using a particle filter 135.

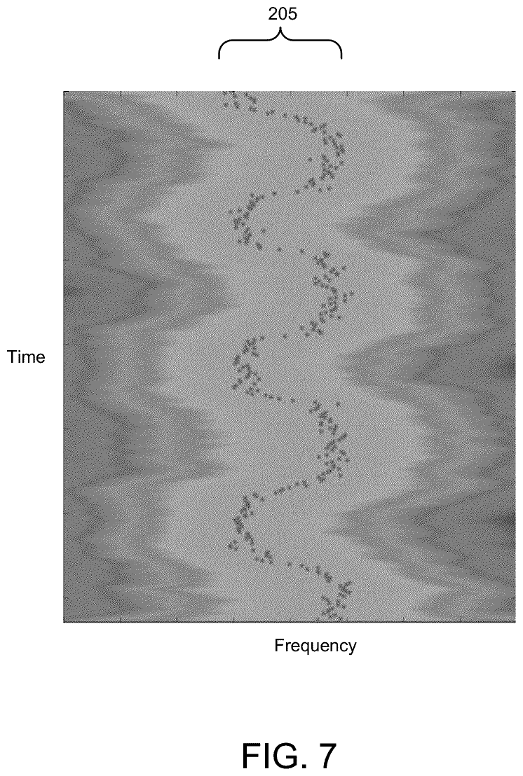

FIG. 7 is a drawing illustrating one embodiment of Doppler extracted from target positions 205 plotted against time and frequency. Light shading corresponds to high transition values yₜ(p, q) and dark shading corresponds to low transition values.

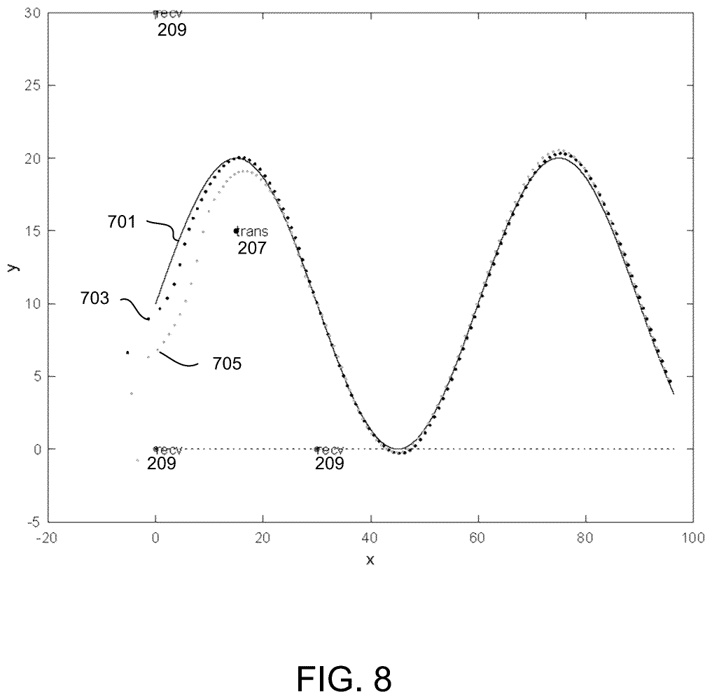

FIG. 8 is a graph illustrating one embodiment of tracking. A simulated track 701 portraying a person walking is shown in x and y spatial coordinates. Receiver positions 209 of receivers 115 and a transmitter position 207 of a transmitter 110 are also shown. The dots indicate the estimate target positions 205 computed using the extended Kalman filter 703 and second order extended Kalman filter 705.

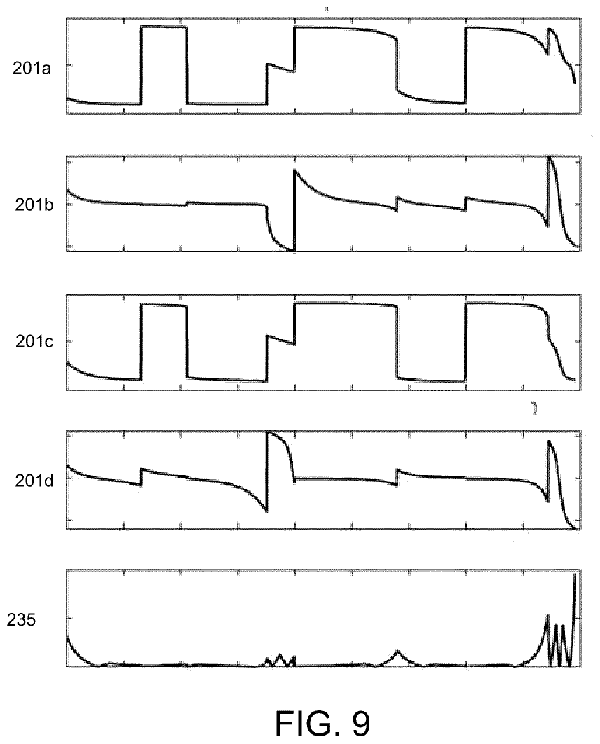

FIG. 9 is graphs illustrating one embodiment of CSI Doppler frequencies 233 from multiple receivers 115. In the depicted embodiment, CSI Doppler frequencies 233a-d are shown for four receivers 115a-d. A minimum Doppler measurement 235 is also shown for the four CSI Doppler frequencies 201a-d.

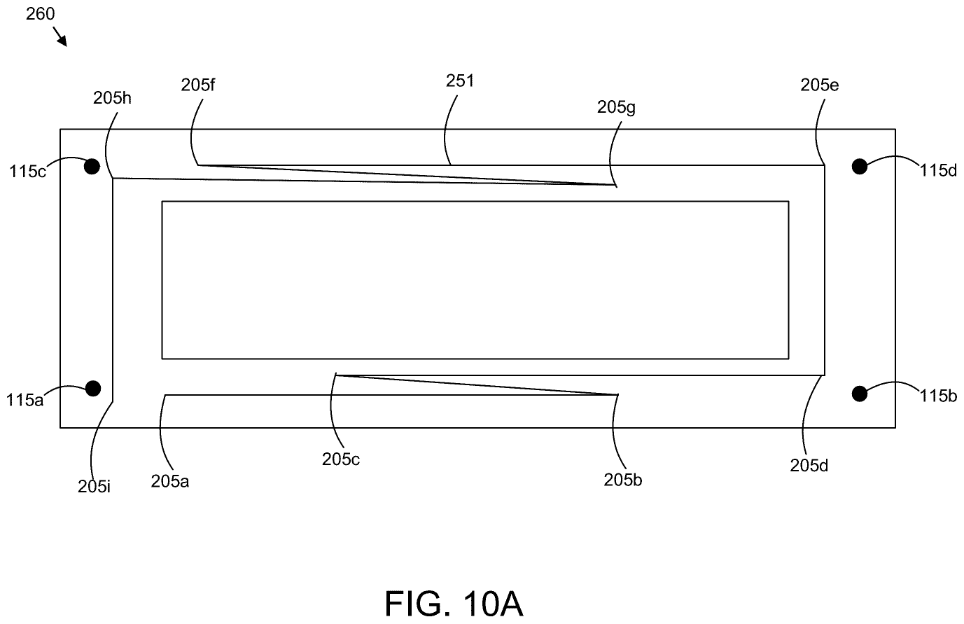

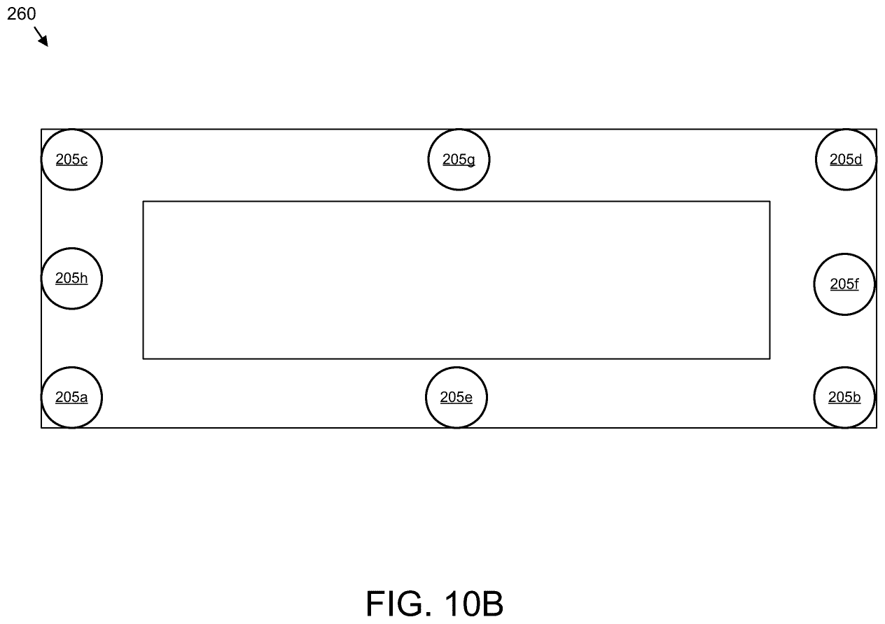

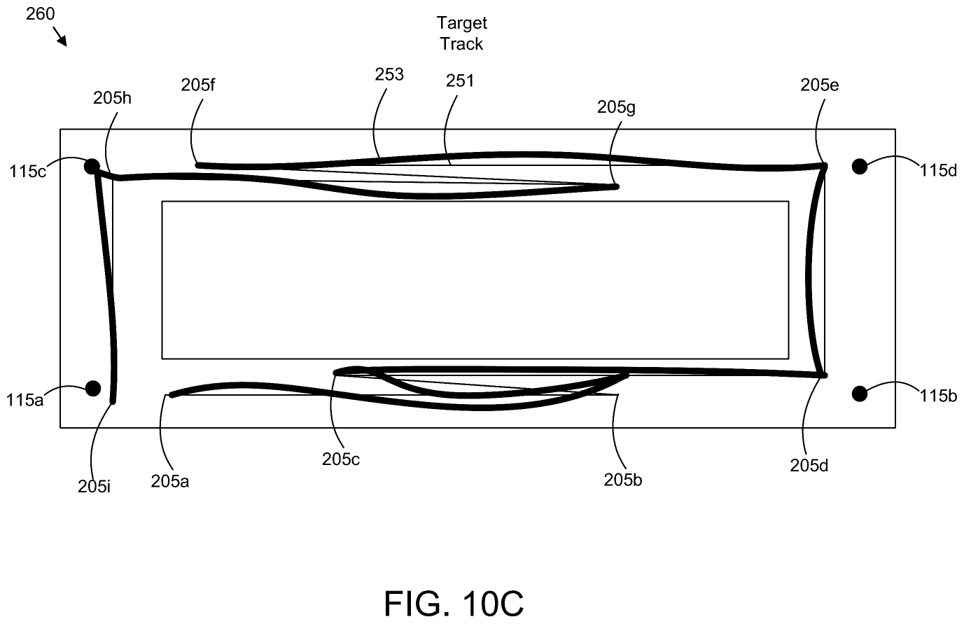

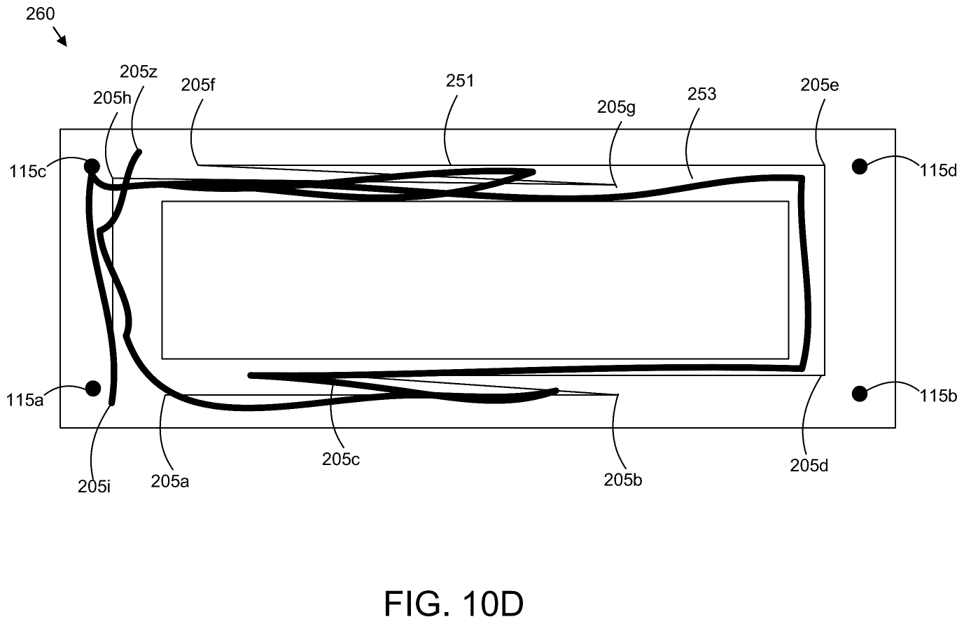

FIG. 10A is a top view drawing illustrating one embodiment of target positions 205 in a building 260. The target 105 proceeds along a target track 251 between target positions 205a-i. The target 105 is tracked using CSI Doppler frequencies 233 from four receivers 115a-d. Three or more receivers 115 may be employed.

FIG. 10B is a top view drawing illustrating one embodiment of initial target positions 205a-g in the building. 260 of FIG. 10A. One initial target position 205 may be selected when tracking a target 105. An initial target velocity vector 103 may also be selected.

FIG. 10C is a top view drawing illustrating one embodiment of estimated target positions 205 in the building 260 starting from a true initial target position 205a. In the depicted embodiment, target positions 205 are computed from the CSI Doppler frequencies 233 using the method 600 of FIG. 6A. A target path 253 is computed from the target positions 205. Because the initial target position was a true initial target position 205a, the target path 253 is accurate.

FIG. 10D is a top view drawing illustrating one embodiment of target positions 205 in the building 260 starting from an incorrect initial target position 205z. The target path 253 is less accurate. However, over time the accuracy of the target path 253 improves. Target positions 205 may be improved using the method 630 of FIG. 6B.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method comprising:
detecting, by use of a processor, that a target is present;
estimating an initial target position; and
tracking the target position from channel state information (CSI) Doppler frequency measurements using at least one of an extended Kalman filter, a Viterbi algorithm, and a particle filter.

2. The method of claim 1, wherein the initial target position is estimated by:
computing position lines of potential target positions reachable from a target position based on a target velocity vector for at least three CSI Doppler frequency measurements based on a sequence of CSI c_{m,n};
computing position intersections of the position lines; and
modifying the target position to minimize differences of the position intersections.

3. The method of claim 2, wherein the target position is modified to a least sum of squares solution for the position intersections.

4. The method of claim 1, wherein the Viterbi algorithm determines points on the position line using a branch metric II (xₙₑₓₜ, yₙₑₓₜ)−(xₙₑₐᵣ, yₙₑₐᵣ) II₂ for each receiver wherein xₙₑₓₜ and yₙₑₓₜ are coordinates of a next point on the position line and xₙₑₐᵣ and yₙₑₐᵣ are coordinates of a near point to the next point.

5. The method of claim 1, the method further tracking the target position by:
receiving a combined signal comprising a target signal reflected by a target and a transmitter signal not reflected by the target, wherein the transmitter signal is comprised of a plurality of orthogonal frequency division multiplexing (OFDM) subcarrier signals;
calculating a signal Fourier transform for the combined signal to obtain the complex symbols zₘ[n], where n is the pilot subcarrier index, m is an OFDM symbol index;
estimating the sequence CSI cm,n for pilot indices of the pilot subcarrier index for the OFDM subcarrier signals of the combined signal as
$${\hat{c}}_{m , n} = ( \frac{{z}_{m} [ n ]}{{pilot}_{m} ( n )} ) ;$$
estimating CSI over for non-pilot OFDM subcarriers of the combined signal to obtain CSI for a sequence of M OFDM symbols;
computing a CSI Fourier transform for the sequence of CSI for a plurality of OFDM subcarriers;
estimating a mean Fourier transform by combining the CSI Fourier transform of the CSI over at least one OFDM subcarrier;
estimating a CSI Doppler frequency by matching a Fourier transform template to the CSI Fourier transform; and
computing each of the target position and the target velocity vector for the target within a field of interest from the CSI Doppler frequency.

6. The method of claim 5, wherein the target position and/or the target velocity vector are determined based on the equation:
$${f}_{d , i , j} ( x ( t ) , y ( t ) , {v}_{x} ( t ) , {v}_{y} ( t ) ) = − \frac{{f}_{c}}{c} [ ( {v}_{x} ( t ) , {v}_{y} ( t ) ) \cdot ( {\frac{( x ( t ) , y ( t ) ) − ( {x}_{T , i} ( t ) , {y}_{T , i} ( t ) )}{‖ ( x ( t ) , y ( t ) ) − ( {x}_{T , i} ( t ) , {y}_{T , i} ( t ) ‖} + \atop \frac{( x ( t ) , y ( t ) ) − ( {x}_{R , j} ( t ) , {y}_{R , j} ( t ) )}{‖ ( x ( t ) , y ( t ) ) − ( {x}_{R , j} ( t ) , {y}_{R , j} ( t ) ‖}} ) - ( {v}_{T , i , x} ( t ) , {v}_{T , i , y} ( t ) ) \cdot \frac{( x ( t ) , y ( t ) − ( {x}_{T , i} ( t ) , {y}_{T , i} ( t ) )}{‖ ( x ( t ) , y ( t ) ) − ( {x}_{T , i} ( t ) , {y}_{T , i} ( t ) ) ‖} - ( {v}_{R , j , x} ( t ) , {v}_{R , j , y} ( t ) ) \cdot \frac{( x ( t ) , y ( t ) ) − ( {x}_{R , j} ( t ) , {y}_{R , j} ( t ) )}{‖ ( x ( t ) , y ( t ) ) − ( {x}_{R , j} ( t ) , {y}_{R , j} ( t ) ) ‖} ] ,$$
$$i = 1 , 2 , … , I , j = 1 , 2 , … , J$$
wherein f_{d,i,j} denotes Doppler frequency determined at receiver j from a signal transmitted at transmitter i, and wherein x(t) and y(t) are a position of the target at time t, x_{R,j}(t) and y_{R,j}(t) are a position of a receiver j at tim5 t, x_{t,j}(t) and y_{T,i}(t) are a position of a transmitter i at time t, vₓ(t) and v_{y}(t) are a velocity of the target at the time t, f_{c} is a carrier frequency of the combined signal.

7. The method of claim 5, wherein the central lobe template is matched to a central lobe of the CSI Fourier transform indicating stationary components, and wherein a side lobe template is matched to side lobes of the Fourier transform indicative of Doppler frequency components.

8. The method of claim 7, wherein the central lobe is offset by a carrier offset frequency.

9. The method of claim 5, wherein the CSI Doppler frequency (233) is calculated using a complex ambiguity function.

10. The method of claim 5, wherein the OFDM symbols transmitted on OFDM subcarrier signals are estimated as
$${\hat{a}}_{m , n} = Q ( \frac{{z}_{m} [ n ]}{{\hat{c}}_{m , n}} ) ,$$
wherein
$$Q ( \frac{{z}_{m} [ n ]}{{\hat{c}}_{m , n}} )$$
represents quantizing
$$( \frac{{z}_{m} [ n ]}{{\hat{c}}_{m , n}} )$$
to a nearest point in the signal space and where ĉ_{m,n} is the estimated CSI.

11. The method of claim 5, wherein combining the CSI Fourier transform of the CSI over the at least one OFDM subcarrier comprises calculating at least one of an average, a sum, a mean, a medium, and a mode.

12. An apparatus comprising:
a processor that executes code stored in a memory to perform:
detecting that a target is present;
estimating an initial target position; and
tracking the target position from channel state information (CSI) Doppler frequency measurements using at least one of an extended Kalman filter, a Viterbi algorithm, and a particle filter.

13. The apparatus of claim 12, wherein the initial target position is estimated by:
computing position lines of potential target positions reachable from a target position based on a target velocity vector for at least three CSI Doppler frequency measurements based on a sequence of CSI cm,n;
computing position intersections of the position lines; and
modifying the target position to minimize differences of the position intersections.

14. The apparatus of claim 13, wherein the target position is modified to a least sum of squares solution for the position intersections.

15. The apparatus of claim 12, wherein the Viterbi algorithm determines points on the position line using a branch metric ∥ (xₙₑₓₜ, yₙₑₓₜ)-(xₙₑₐᵣ, yₙₑₐᵣ) μ² for each receiver wherein xₙₑₓₜ and yₙₑₓₜ are coordinates of a next point on the position line and xₙₑₐᵣ and yₙₑₐᵣ are coordinates of a near point to the next point.

16. The apparatus of claim 12, the processor further tracking the target position by:
receiving a combined signal comprising a target signal reflected by a target and a transmitter signal not reflected by the target, wherein the transmitter signal is comprised of a plurality of orthogonal frequency division multiplexing (OFDM) subcarrier signals;
calculating a signal Fourier transform for the combined signal to obtain the complex symbols zₘ[n], where n is the pilot subcarrier index, m is an OFDM symbol index; and
estimating the sequence CSI cm,n for pilot indices of the pilot subcarrier index for the OFDM
$${\hat{c}}_{m , n} = ( \frac{{z}_{m} [ n ]}{{pilot}_{m} ( n )} ) ;$$
subcarrier signals of the combined signal as estimating CSI over for non-pilot OFDM subcarriers of the combined signal to obtain CSI for a sequence of M OFDM symbols;
computing a CSI Fourier transform for the sequence of CSI for a plurality of OFDM subcarriers;
estimating a mean Fourier transform by combining the CSI Fourier transform of the CSI over at least one OFDM subcarrier;
estimating a CSI Doppler frequency by matching a Fourier transform template to the CSI Fourier transform; and
computing each of the target position and the target velocity vector for the target within a field of interest from the CSI Doppler frequency.

17. The apparatus of claim 16, wherein the target position and/or the target velocity vector are determined based on the equation:
$${f}_{d , i , j} ( x ( t ) , y ( t ) , {v}_{x} ( t ) , {v}_{y} ( t ) ) = − \frac{{f}_{c}}{c} [ ( {v}_{x} ( t ) , {v}_{y} ( t ) ) \cdot ( {\frac{( x ( t ) , y ( t ) ) − ( {x}_{T , i} ( t ) , {y}_{T , i} ( t ) )}{‖ ( x ( t ) , y ( t ) ) − ( {x}_{T , i} ( t ) , {y}_{T , i} ( t ) ‖} + \atop \frac{( x ( t ) , y ( t ) ) − ( {x}_{R , j} ( t ) , {y}_{R , j} ( t ) )}{‖ ( x ( t ) , y ( t ) ) − ( {x}_{R , j} ( t ) , {y}_{R , j} ( t ) ‖}} ) - ( {v}_{T , i , x} ( t ) , {v}_{T , i , y} ( t ) ) \cdot \frac{( x ( t ) , y ( t ) − ( {x}_{T , i} ( t ) , {y}_{T , i} ( t ) )}{‖ ( x ( t ) , y ( t ) ) − ( {x}_{T , i} ( t ) , {y}_{T , i} ( t ) ) ‖} - ( {v}_{R , j , x} ( t ) , {v}_{R , j , y} ( t ) ) \cdot \frac{( x ( t ) , y ( t ) ) − ( {x}_{R , j} ( t ) , {y}_{R , j} ( t ) )}{‖ ( x ( t ) , y ( t ) ) − ( {x}_{R , j} ( t ) , {y}_{R , j} ( t ) ) ‖} ] ,$$
$$i = 1 , 2 , … , I , j = 1 , 2 , … , J$$
wherein f_{d,i,j} denotes Doppler frequency determined at receiver j from a signal transmitted at transmitter i, and wherein x(t) and y(t) are a position of the target at time t, x_{R,j}(t) and Y_{R,j}(t) are a position of a receiver j at tim5 t, X_{T,j}(t) and y_{T,i}(t) are a position of a transmitter i at time t, vₓ(t) and vy (t) are a velocity of the target (105) at the time t, f_{c} is a carrier frequency of the combined signal.

18. The apparatus of claim 16, wherein the central lobe template is matched to a central lobe of the CSI Fourier transform indicating stationary components, and wherein a side lobe template is matched to side lobes of the Fourier transform indicative of Doppler frequency components.

19. The method of claim 18, wherein the central lobe is offset by a carrier offset frequency.

20. A computer program product comprising a non-transitory computer readable storage medium storing code that is executed by a processor to perform:
detecting that a target is present;
estimating an initial target position; and
tracking the target position from channel state information (CSI) Doppler frequency measurements using at least one of an extended Kalman filter, a Viterbi algorithm, and a particle filter.
